(19) United States
(12) Patent Application Publication
(10) Pub. No.: US 2011/0176272 A1
(43) Pub. Date: Jul. 21, 2011

(54) FLAP LID FOR USE IN COMPUTER ENCLOSURE OR HOT-PLUGGING DISK DRIVE ENCLOSURE

(76) Inventor: Yen-Te HSIAO, Hsinchuang City (TW)

(21) Appl. No.: 12/900,492

(22) Filed: Oct. 8, 2010

(30) Foreign Application Priority Data
Jan. 15, 2010 (TW) 098222177

(51) Int. Cl. G06F 1/16

(52) U.S. Cl. 361/679.37

(57) ABSTRACT

A flap lid structure is provided for use in a computer enclosure or a hot plugging hard disk drive enclosure and includes a front cover for the computer enclosure or the hot plugging hard disk drive enclosure and forming a receiving opening that has one side forming a mounting edge, a major lid having corresponding in size to the receiving opening and mounted to the mounting edge through a spring-encompassed pivot, and a minor lid received in the receiving opening of the front cover and mounted to one side of the receiving opening that is opposite to the mounting edge through a spring-encompassed pivot. The major lid forms a cutoff corresponding in size and location to the minor lid. The flap lid ensures the receiving opening defined in the front cover of a computer enclosure in a substantially closed condition to effectively prevent invasion of dusts and oily smokes.

### (a) TECHNICAL FIELD OF THE INVENTION

The present invention generally relates to a flap lid for use in computer enclosure or had disk drive case or enclosure, and more particularly to a flap lid that is mounted at a receiving opening of a computer enclosure or a hot plugging hard disk drive case or enclosure to ensure effective closure and protection against invasion of dusts and oily smokes under any possible conditions of use.

### (b) DESCRIPTION OF THE PRIOR ART

With the popularity of use of computer and the progress of networking technology, digitalized information available for the general consumers is getting much richer than ever. Video files taken with camera devices, educational data acquired from networks, and entertainment programs are all easily available, but a great amount of storage is needed for these digitalized data. Due to such a factor, the capacity of storage, such as a hard disk drive, as well as the easiness of use of storage, is now of increasing demand for further improvement. This demand makes hot-plugging hard disk drive of large capacity become a new trend. The availability of a computer with hot-plugging capability helps hot plugging of an ordinary hard disk drive, makes addition of multiple hard disk drives easy, and also supports hard disk drives of different specifications, such as 3.5″ and 2.5″ hard disk drives.

A hot plugging hard disk drive can be received and fixed in an access opening or a receiving channel defined in a front panel of a computer enclosure, or alternatively, the hot plugging hard disk drive is first received in a hard disk drive enclosure that has a hard disk drive fit-in slot defined in a front panel thereof and then the hard disk drive enclosure is mounted inside a computer enclosure. To prevent invasion of dusts into the hot plugging hard disk drive, the access opening or fit-in slot defined in the computer enclosure or the hard disk drive enclosure is provided with a flap lid that is of a size and shape complementary to the access opening or the fit-in slot. One side wall of the opening or slot forms a mounting edge and the flap lid is mounted to the mounting edge with spring encompassed pivots.

The computer enclosure or the hard disk drive enclosure often has open voids or gaps, which become passages for the entry of dusts and oily smoke. The dusts and oily smokes that invade the enclosure are often attached to components/assemblies arranged inside the enclosure, leading to deterioration of heat dissipation. Further, it is even worse that under certain conditions, the dusts and oily smokes attached to the internal components/assemblies may lead to shorting, which eventually damages of a main board of the computer and reduction of service life of hardware. Due to protection against of dusts, most of the computer enclosures or hard disk drive enclosures are provided with a flap lid, which substantially shields the computer enclosure or the hard disk drive. The flap lid is conventionally of a size corresponding to a 3.5″ hard disk drive. This makes it not possible to complete close or shield an opening or slot that receives the insertion of a 2.5″ hard disk drive and a gap is formed around the hard disk drive. On the other hand, if the flap lid is made of the size corresponding to a 2.5″ hard disk drive, then the opening or slot is not capable of receiving the insertion of a 3.5″ hard disk drive. If a flap lid of a size corresponding to 3.5″ hard disk drive is used and is cut at a side corresponding to the mounting edge to form a secondary opening that is of a size corresponding to 2.5″ hard disk drive, then once an originally installed hard disk drive is removed, an opening is present in the computer enclosure. It is generally not possible for the conventional arrangements to realize closure of the computer enclosure or hard disk drive enclosure in all possible conditions of use.

### SUMMARY OF THE INVENTION

The primary objective of the present invention is to provide a flap lid that is use in a computer enclosure or a hard disk drive enclosure and is fit for two sizes of hard disk drives, whereby with the use of such a flap lid, a receiving opening formed in the computer enclosure or hard disk drive enclosure may selectively receive a first size hard disk drive or a second size hard disk drive or even receive no hard disk drive without any undesired formation of gap due to unoccupied space of the receiving opening and thus effectively preventing invasion of dust and oily smoke into the enclosure.

According to the present invention, the above objective is realized through the following technical solution. A flap lid for use in a computer enclosure or a hard disk drive enclosure is provided, comprising a front cover for the computer enclosure or the hot plugging hard disk drive enclosure and forming a receiving opening that has one side forming a mounting edge, a major lid corresponding in size to the receiving opening and mounted to the mounting edge through a pivot that is encompassed by a torsion spring, and characterized in that a minor lid is additionally mounted in the receiving opening of the front cover, the minor lid being mounted to one side of the receiving opening that is opposite to the mounting edge through a spring-encompassed pivot, the major lid forming a cutoff corresponding in size and location to the minor lid.

Based on the above arrangement, the present invention comprises a further improvement in that the minor lid comprises a minor right pivot and a minor left pivot, which are respectively received in and supported by bearing holes defined in bearing tabs arranged at two sides of the receiving opening of the front cover.

The bearing hole of one of the bearing tabs arranged at two sides of the receiving opening of the front cover and supporting the minor pivots of the minor lid forms a sideway opening that has a width less than diameter of the bearing hole and is in communication between inside and outside of the bearing hole. The minor right pivot of the minor lid that corresponds to the one of the bearing holes having a sideway opening has an end that is truncated to form a sloped incision, whereby the truncated minor pivot end has a cross-sectional dimension that corresponds to the width of the sideway opening of the bearing hole to allow the truncated end of the minor pivot to be received through the sideway opening for entry into the bearing hole.

The minor left pivot of the minor lid is provided with a torsion spring encompassing the minor left pivot and the minor left pivot is directly fit into the bearing hole of the corresponding bearing tab.

The major lid comprises a major right pivot and a major left pivot, which are respectively received in and supported by bearing holes defined in bearing tabs arranged at two sides of the receiving opening of the front cover.

The bearing hole of one of the bearing tabs arranged at two sides of the receiving opening of the front cover and supporting the major pivots of the major lid forms a sideway opening that has a width less than diameter of the bearing hole and is in communication between inside and outside of the bearing hole. The major left pivot of the major lid that corresponds to the one of the bearing holes having a sideway opening has an end that is truncated to form a sloped incision, whereby the truncated major pivot end has a cross-sectional dimension that corresponds to the width of the sideway opening of the bearing hole to allow the truncated end of the major pivot to be received through the sideway opening for entry into the bearing hole.

The major right pivot of the major lid is provided with a torsion spring encompassing the major right pivot and the major right pivot is directly fit into the bearing hole of the corresponding bearing tab.

To mount the minor lid, the spring-encompassed pivot of the lid is directly fit into the bearing hole of the corresponding bearing tab. In a condition where the spring is deformed and the minor lid is substantially perpendicular to the front cover, the truncated end of the opposite pivot of the minor lid is received through the sideway opening into and thus retained inside a circular internal space of the bearing hole. After the assembling, under the action of the spring, the minor lid is automatically rotated upward by approximately 90 degrees to shield the receiving opening of the front cover and the spring restores the original condition thereof.

To remove the minor lid, the minor lid is rotated to a position substantially perpendicular to the front cover, under which condition, the spring is deformed. The truncated end of the pivot of the minor lid is first removed out of the bearing hole through the sideway opening and then the opposite pivot, which is encompassed by the spring, is removed out of the bearing hole of the corresponding bearing tab.

The major lid is mounted to a side of the receiving opening of the front cover that is opposite to the side to which the minor lid is mounted through pivots that are of the same structural arrangement and operation as those of the minor lid. The dismounting of the major lid is also the same as that of the minor lid.

The present invention provides a flap lid structure that is applicable to both 3.5″ and 2.5″ hard disk drives and that effectively preventing invasion of dusts and oily smokes into a computer enclosure or a hot plugging hard disk drive enclosure by completely closing an opening defined in a front cover of a hard disk drive case and receiving the 2.5″ or 3.5″ hard disk drive therein and that is advantageous in that both a major lid and a minor lid can be easily mounted and dismounted.

The present invention also provides an LED (Light-Emitting Diode) for indicating the status of the hard disk drive. The LED is wire-connected to a SATA adaption connector and is received and mounted in a hole defined in the front cover.

The present invention provides a flap lid structure that is applicable to both 3.5″ and 2.5″ hard disk drives and that effectively preventing invasion of dusts and oily smokes into a computer enclosure or a hot plugging hard disk drive enclosure by completely closing an opening defined in a front cover of a hard disk drive case and receiving the 2.5″ or 3.5″ hard disk drive therein and that is advantageous in that both a major lid and a minor lid can be easily mounted and dismounted.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view, taken from the front side, of an embodiment according to the present invention.

FIG. 2 is a perspective view, taken from the rear side, of the embodiment of the present invention.

FIG. 3 is an exploded view of the embodiment of the present invention.

FIG. 4 is a perspective view, taken from the front side, of a front cover of the present invention with a major lid and a minor lid being opened.

FIG. 5 is a perspective view, taken from the rear side, of the front cover of the present invention with the major lid and the minor lid opened.

FIG. 6 is a perspective view, taken from the front side, of the front cover of the present invention with a major lid closed and a minor lid open.

FIG. 7 is a perspective view, taken from the rear side, of the front cover of the present invention with a major lid closed and a minor lid open.

FIG. 8 is an enlarged view of a portion of a spring-encompassed pivot of the major lid of the present invention.

FIG. 9 is an enlarged view of a portion of an end-truncated pivot of the major lid of the present invention.

FIG. 10 is an enlarged view of a portion of an end-truncated pivot of the minor lid of the present invention.

FIG. 11 is an enlarged view of a portion of a spring-encompassed pivot of the minor lid of the present invention.

FIG. 12 is perspective views illustrating the present invention directly mounted to a front panel of a computer enclosure.

FIG. 13 is a perspective view showing the present invention directly mounted to a top board of a computer enclosure.

FIG. 14 is another perspective view showing the present invention directly mounted to a top board of a computer enclosure.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

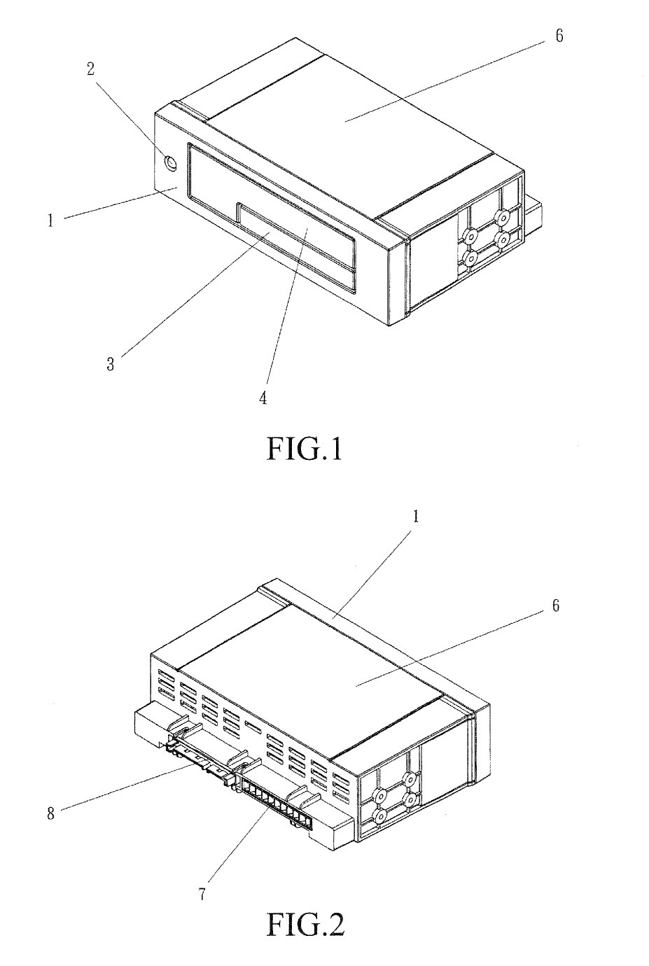

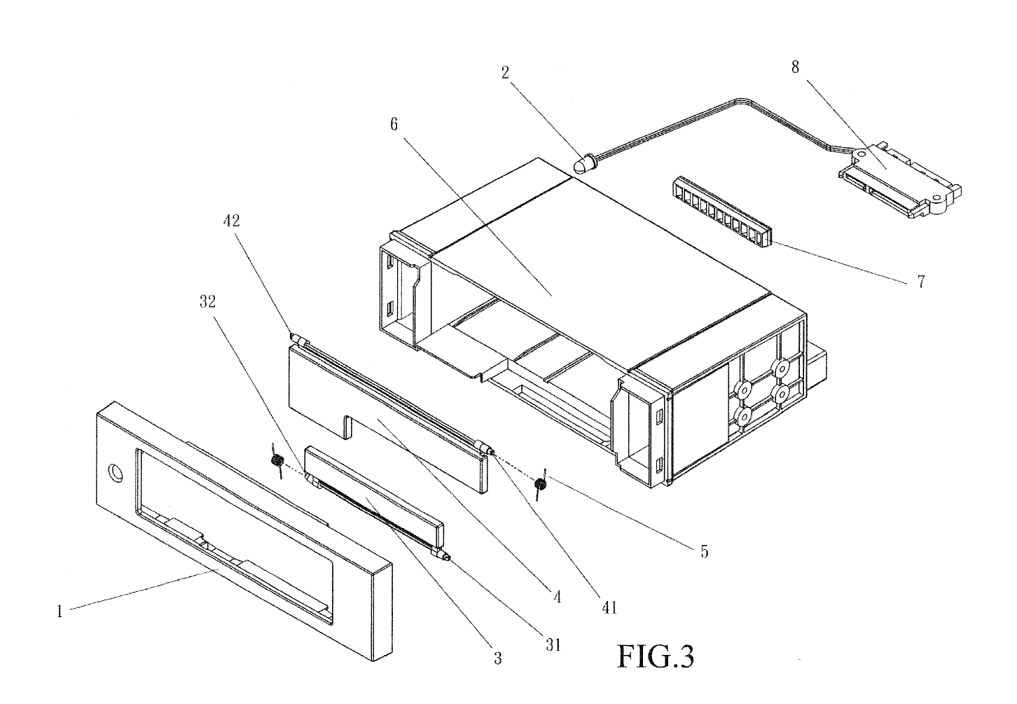

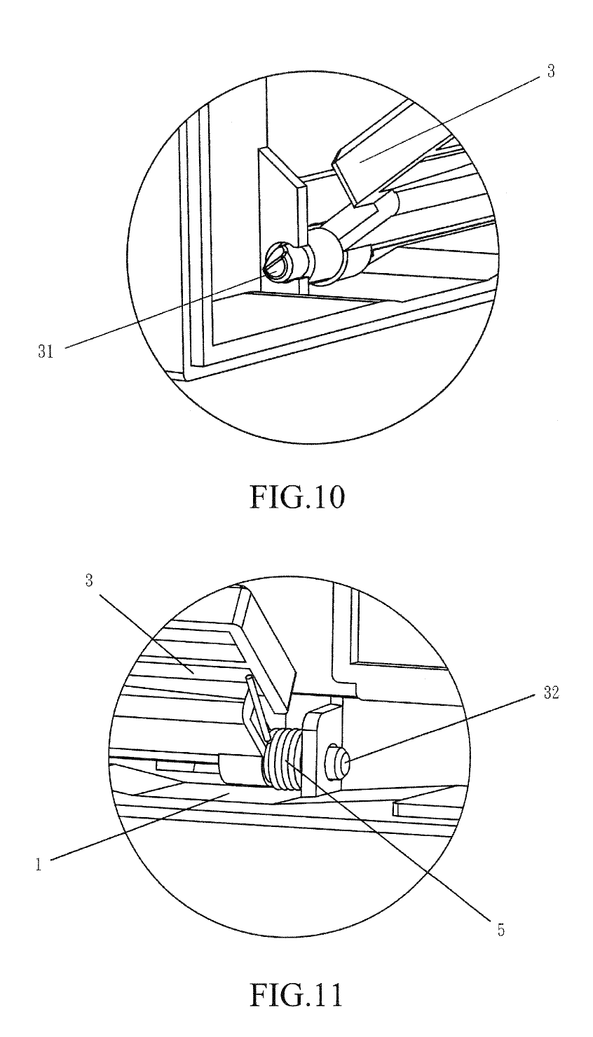

Referring to FIGS. 1 and 3, which respectively show a perspective view and an exploded view of an embodiment according to the present invention, the embodiment of present invention comprises a front cover 1, an LED (Light-Emitting Diode) 2, a minor lid 3, minor lid pivots, a major lid 4, major lid pivots, a torsion springs 5, a rear housing 6, a retention board 7, and as SATA adaption connector 8. The pivots of the minor lid 3 are respectively minor lid left pivot 32 and minor lid right pivot 31, which are respectively received in and supported by bearing holes defined in bearing tabs arranged at two lateral sides of the opening of the front cover 1. The bearing hole of one of the bearing tabs forms a sideway opening that has ,a size or width less than the diameter of the bearing hole and is in communication between inside and outside of the bearing hole. The right pivot 31 of the minor lid 3 that corresponds to the one of the bearing holes having a sideway opening has an end that is truncated to form a sloped incision, whereby the pivot end 31, after having been truncated, has a cross-sectional dimension or width that corresponds to the width of the sideway opening of the bearing hole to allow the truncated end 31 of the lid pivot to be received through the sideway opening for entry into the bearing hole. The left pivot 32 of the minor lid 3 is provided with a torsion spring encompassing the pivot and the left pivot is directly fit into the bearing hole of the corresponding bearing tab, as shown in FIGS. 8-11.

The pivots of the major lid 4 are also referred to as major lid right pivot 41 and major lid left pivot 42, which are respectively received in and supported by bearing holes defined in bearing tabs arranged at two lateral sides of the opening of the front cover 1. The bearing hole of one of the bearing tabs forms a sideway opening that has a size or width less than the diameter of the bearing hole and is in communication between inside and outside of the bearing hole. The pivot 42 of the major lid 4 that corresponds to the one of the bearing holes having a sideway opening has an end that is truncated to form a sloped incision, whereby the pivot end 42, after having been truncated, has a cross-sectional dimension or width that corresponds to the width of the sideway opening of the bearing hole to allow the truncated end 42 of the lid pivot to be received through the sideway opening for entry into the bearing hole. The right pivot 41 of the major lid 4 is provided with a torsion spring encompassing the pivot and the pivot is directly fit into the bearing hole of the corresponding bearing tab on a mounting edge of the major lid.

The LED 2 is wire-connected to the SATA adaption connector 8 and is received and retained in a hole defined in the front cover 1. The retention board 7 and the SATA adaption connector 8 are both mounted to the rear housing 6. The front cover 1 and the rear housing 6 are combinable with each other to form the complete enclosure.

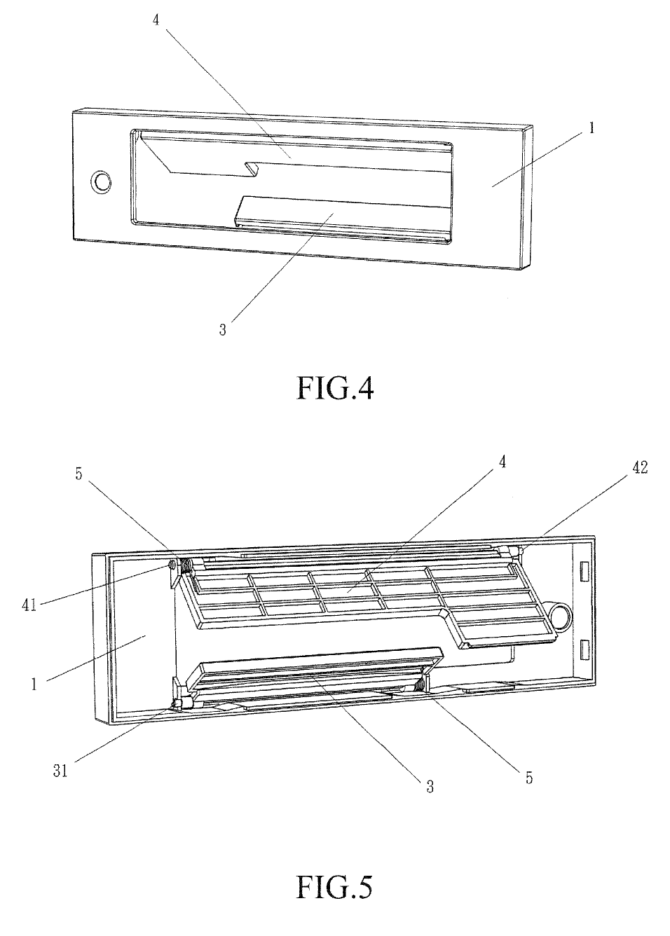

In use, to insert a 3.5″ hard disk drive, both the major and minor lids are opened inwards, a shown in FIGS. 4 and 5. When a user pushes the hard disk drive to forcibly insert into the hard disk drive enclosure or the computer enclosure, both the major and minor flap lids are turned inward due to the insertion force and under this condition and the torsion springs are deformed, whereby the major and minor lids no long shield the receiving opening of the front cover. After the hard disk drive is completely installed in the enclosure, the major and minor lids are constrained between the hard disk drive and the inside walls of the enclosure, not allowed to rotate. On the other hand, once the hard disk drive is removed from the receiving opening, the major and minor lids are acted upon by the spring forces of the torsion springs to return back to the original position where the major and minor lids shield the receiving opening of the front cover.

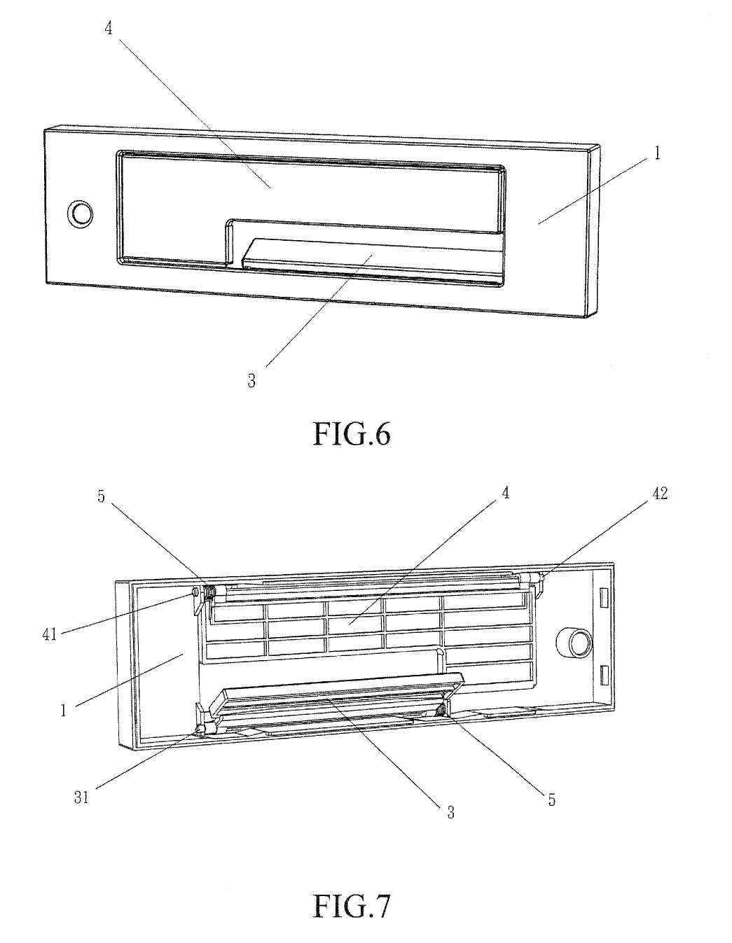

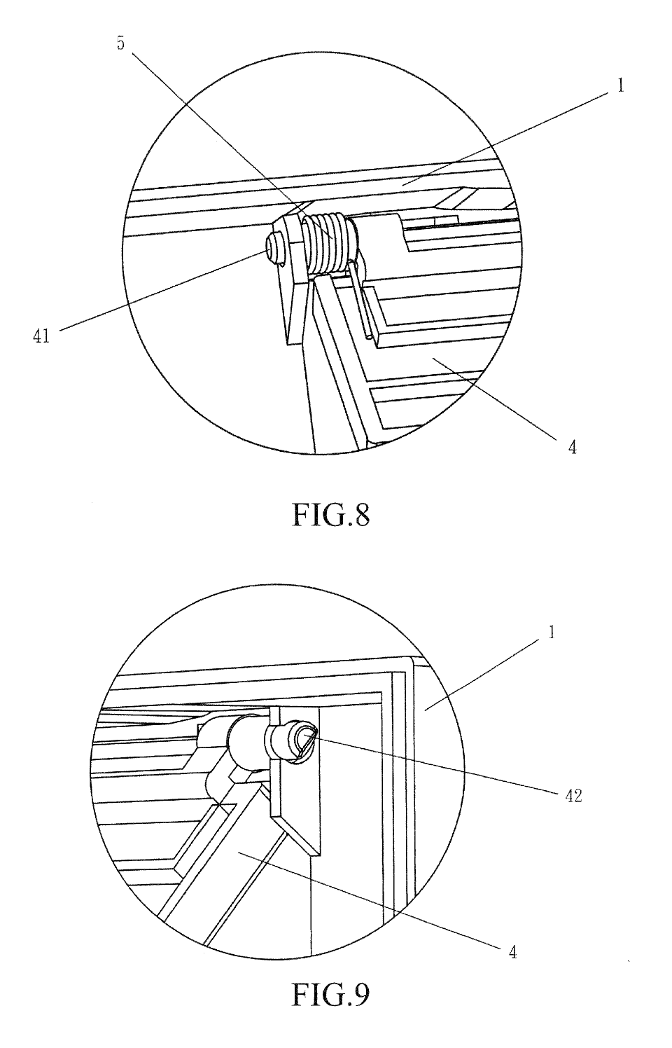

In use, to insert a 2.5″ hard disk drive into the enclosure, the minor lid is moved inward, as shown in FIGS. 6 and 7. The operation is substantially the same as that discussed above.

Referring to FIGS. 8-11, enlarged views of the spring-encompassed pivot and the end-truncated pivot of the major lid and the spring-encompassed pivot and the end-truncated pivot of the minor lid are shown. The pivot 31 of the minor lid 3 is truncated to show a configuration of inclined incision and the cross-sectional dimension of the truncated end substantially corresponds to the width of the sideway opening of the bearing hole associated with the pivot. The truncated pivot 31 is thus allowed to pass through the sideway opening and thus received into the bearing hole. The opposite pivot 32 of the minor lid is encompassed by the torsion spring. The arrangement and mounting/dismounting operation of the two pivots of the major lid are the same as those of the minor lid.

In a practical operation, both the major and minor lids can be easily removed as desired. For example, to mount a 3.5″ hard disk drive, both the major and minor lids are first removed and then the receiving opening is not shielded, allowing the hard disk drive to be mounted inside the enclosure. On the other hand, to mount a 2.5″ hard disk drive, only the minor lid is removed to allow the hard disk drive to be put into the enclosure for mounting.

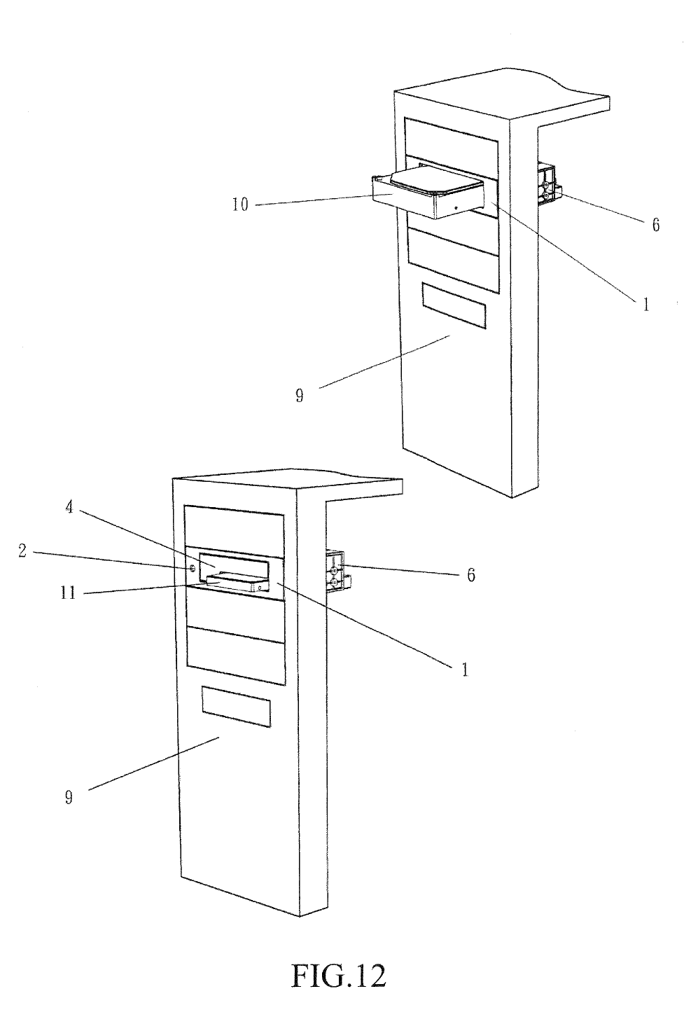

Referring to FIG. 12, the present invention is shown directly mounted to the front panel of a computer enclosure, illustrating how 3.5″ and 2.5″ hard disk drives 10, 11 are mounted to the front panel. Further, to mount the hard disk drive, the front cover 1 is set to correspond to a front opening of the computer enclosure 9. It is feasible to mount one or more hard disk drive cases or enclosure according to the design and practical application of the computer enclosure. This drawing shows only one hard disk drive case is mounted.

In addition, the present invention can be directly formed on a computer enclosure to realize an integrated structure of combined hot plugging hard disk drive enclosure and computer enclosure.

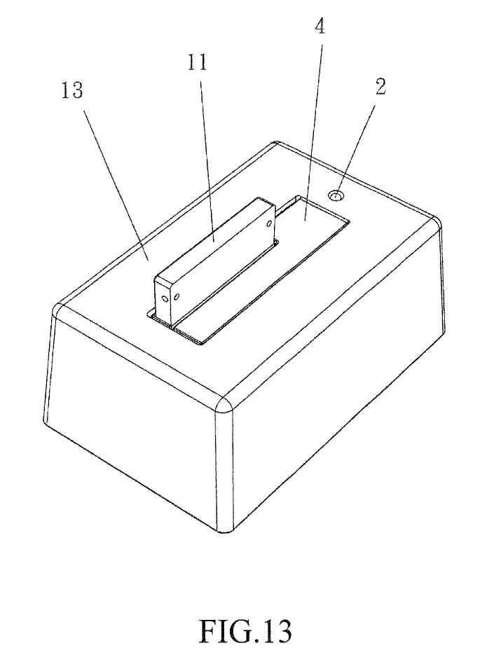

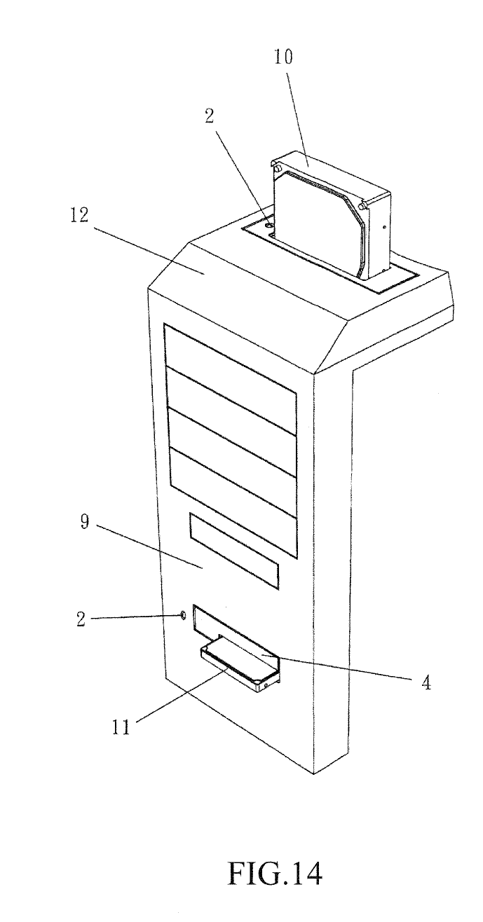

Referring to FIGS. 13 and 14, the present invention is shown directly mounted on a top board of computer enclosure. The front cover 1 is directly formed on a front panel 9 of computer enclosure, namely a portion or a front panel 9 or a top board 12 of the computer enclosure being used to serve as the front cover 1. To mount a 2.5″ hard disk drive 11 to the top board 12 of the computer enclosure, the minor lid arranged on the top board 12 is turned inward or removed. To mount a 3.5″ hard disk drive 10 to the front panel 9 of the computer enclosure, both the major and minor lids are turned inward or removed.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the foims and details of the device illustrated and in its operation can be made by those skilled in the art without departing in any way from the spirit of the present invention.

I claim:

1. A flap lid structure for use in a computer enclosure or a hot plugging hard disk drive enclosure, comprising a front cover for the computer enclosure or the hot plugging hard disk drive enclosure and forming a receiving opening that has one side forming a mounting edge, a major lid having corresponding in size to the receiving opening and mounted to the mounting edge through a pivot that is encompassed by a torsion spring, a minor lid being additionally mounted in the receiving opening of the front cover, the minor lid being mounted to one side of the receiving opening that is opposite to the mounting edge through a spring-encompassed pivot, the major lid forming a cutoff corresponding in size and location to the minor lid.

2. The flap lid structure for use in a computer enclosure or a hot plugging hard disk drive enclosure according to claim 1, wherein the minor lid comprises a minor right pivot and a minor left pivot, which are respectively received in and supported by bearing holes defined in bearing tabs arranged at two sides of the receiving opening of the front cover.

3. The flap lid structure for use in a computer enclosure or a hot plugging hard disk drive enclosure according to claim 2, wherein the bearing hole of one of the bearing tabs arranged at two sides of the receiving opening of the front cover and supporting the minor pivots of the minor lid forms a sideway opening that has a width less than diameter of the bearing hole and is in communication between inside and outside of the bearing hole and wherein the minor right pivot of the minor lid that corresponds to the one of the bearing holes having a sideway opening has an end that is truncated to form a sloped incision, whereby the truncated minor pivot end has a cross-sectional dimension that corresponds to the width of the sideway opening of the bearing hole to allow the truncated end of the minor pivot to be received through the sideway opening for entry into the bearing hole.

4. The flap lid structure for use in a computer enclosure or a hot plugging hard disk drive enclosure according to claim 3, wherein the minor left pivot of the minor lid is provided with a torsion spring encompassing the minor left pivot and the minor left pivot is directly fit into the bearing hole of the corresponding bearing tab.

5. The flap lid structure for use in a computer enclosure or a hot plugging hard disk drive enclosure according to claim 1, wherein the major lid comprises a major right pivot and a major left pivot, which are respectively received in and supported by bearing holes defined in bearing tabs arranged at two sides of the receiving opening of the front cover.

6. The flap lid structure for use in a computer enclosure or a hot plugging hard disk drive enclosure according to claim 5, wherein the bearing hole of one of the bearing tabs arranged at two sides of the receiving opening of the front cover and supporting the major pivots of the major lid forms a sideway opening that has a width less than diameter of the bearing hole and is in communication between inside and outside of the bearing hole and wherein the major left pivot of the major lid that corresponds to the one of the bearing holes having a sideway opening has an end that is truncated to form a sloped incision, whereby the truncated major pivot end has a cross-sectional dimension that corresponds to the width of the sideway opening of the bearing hole to allow the truncated end of the major pivot to be received through the sideway opening for entry into the bearing hole.

7. The flap lid structure for use in a computer enclosure or a hot plugging hard disk drive enclosure according to claim 6, wherein the major right pivot of the major lid is provided with a torsion spring encompassing the major right pivot and the major right pivot is directly fit into the bearing hole of the corresponding bearing tab.

8. The flap lid structure for use in a computer enclosure or a hot plugging hard disk drive enclosure according to claim 2, wherein the major lid comprises a major right pivot and a major left pivot, which are respectively received in and supported by bearing holes defined in bearing tabs arranged at two sides of the receiving opening of the front cover.

9. The flap lid structure for use in a computer enclosure or a hot plugging hard disk drive enclosure according to claim 8, wherein the bearing hole of one of the bearing tabs arranged at two sides of the receiving opening of the front cover and supporting the major pivots of the major lid forms a sideway opening that has a width less than diameter of the bearing hole and is in communication between inside and outside of the bearing hole and wherein the major left pivot of the major lid that corresponds to the one of the bearing holes having a sideway opening has an end that is truncated to form a sloped incision, whereby the truncated major pivot end has a cross-sectional dimension that corresponds to the width of the sideway opening of the bearing hole to allow the truncated end of the major pivot to be received through the sideway opening for entry into the bearing hole.

10. The flap lid structure for use in a computer enclosure or a hot plugging hard disk drive enclosure according to claim 9, wherein the major right pivot of the major lid is provided with a torsion spring encompassing the major right pivot and the major right pivot is directly fit into the bearing hole of the corresponding bearing tab.

11. The flap lid structure for use in a computer enclosure or a hot plugging hard disk drive enclosure according to claim 3, wherein the major lid comprises a major right pivot and a major left pivot, which are respectively received in and supported by bearing holes defined in bearing tabs arranged at two sides of the receiving opening of the front cover.

12. The flap lid structure for use in a computer enclosure or a hot plugging hard disk drive enclosure according to claim 11, wherein the bearing hole of one of the bearing tabs arranged at two sides of the receiving opening of the front cover and supporting the major pivots of the major lid forms a sideway opening that has a width less than diameter of the bearing hole and is in communication between inside and outside of the bearing hole and wherein the major left pivot of the major lid that corresponds to the one of the bearing holes having a sideway opening has an end that is truncated to form a sloped incision, whereby the truncated major pivot end has a cross-sectional dimension that corresponds to the width of the sideway opening of the bearing hole to allow the truncated end of the major pivot to be received through the sideway opening for entry into the bearing hole.

13. The flap lid structure for use in a computer enclosure or a hot plugging hard disk drive enclosure according to claim 12, wherein the major right pivot of the major lid is provided with a torsion spring encompassing the major right pivot and the major right pivot is directly fit into the bearing hole of the corresponding bearing tab.

14. The flap lid structure for use in a computer enclosure or a hot plugging hard disk drive enclosure according to claim 4, wherein the major lid comprises a major right pivot and a major left pivot, which are respectively received in and supported by bearing holes defined in bearing tabs arranged at two sides of the receiving opening of the front cover.

15. The flap lid structure for use in a computer enclosure or a hot plugging hard disk drive enclosure according to claim 14, wherein the bearing hole of one of the bearing tabs arranged at two sides of the receiving opening of the front cover and supporting the major pivots of the major lid forms a sideway opening that has a width less than diameter of the bearing hole and is in communication between inside and outside of the bearing hole and wherein the major left pivot of the major lid that corresponds to the one of the bearing holes having a sideway opening has an end that is truncated to form a sloped incision, whereby the truncated major pivot end has a cross-sectional dimension that corresponds to the width of the sideway opening of the bearing hole to allow the truncated end of the major pivot to be received through the sideway opening for entry into the bearing hole.

16. The flap lid structure for use in a computer enclosure or a hot plugging hard disk drive enclosure according to claim 15, wherein the major right pivot of the major lid is provided with a torsion spring encompassing the major right pivot and the major right pivot is directly fit into the bearing hole of the corresponding bearing tab.
